(19) United States
(12) Patent Application Publication
(10) Pub. No.: US 2026/0234292 A1
(43) Pub. Date: Aug. 13, 2026

(54) METHOD FOR PRODUCING LONG CHAIN CELLULOSE ESTER, LONG CHAIN CELLULOSE ESTER AND ITS USE

(71) Applicant: Kemira Oyj, Helsinki (FI)

(72) Inventors: Riina TAKAMAA, Espoo (FI); Viktor KUKKONEN, Espoo (FI)

(21) Appl. No.: 19/160,585

(22) PCT Filed: Feb. 27, 2024
(86) PCT No.: PCT/FI2024/050071

§ 371 Date: Aug. 28, 2025

(30) Foreign Application Priority Data
Feb. 28, 2023 (FI) 20235244

(51) Int. Cl. C08B 3/10; D21H 17/27; D21H 21/16

(52) U.S. Cl. CPC C08B 3/10; D21H 17/27; D21H 21/16

(57) ABSTRACT

A method for producing long chain cellulose esters by a mechanochemical synthesis. The method comprises esterification of cellulose by mixing and subjecting to mechanical forces at least cellulose, a fatty acid and/or a fatty acid derivative comprising a chain length of at least C6, an alkali salt, and a neutral or alkaline drying agent, wherein the long chain cellulose esters are obtained, which cellulose esters comprise a fatty acid having chain length of at least C6. In a method, esterification of cellulose is performed without using any organic solvents.

### FIELD OF THE INVENTION

The present invention relates to a method for producing a long chain cellulose ester according to the claims presented below. The invention relates to a long chain cellulose ester obtained by the method according to the present invention, and its use.

### BACKGROUND OF THE INVENTION

Progress in biomass-based plastics from renewable resources has been accelerating in the face of petroleum resource depletion and global climate change. Moreover, due to the possibility of future food shortages, the use of edible plant resources to produce bioplastics is not preferred. Cellulose is the most abundant natural polymer, and hence it is an attractive feedstock to bio-based materials and to replace fossil-based polymers. Cellulose esters represent a class of commercially important thermoplastic polymers with good barrier properties making them attractive for example for packaging and textile industry. Classical short-chain cellulose esters, such as cellulose acetate and cellulose acetate propionate, are derived from fossil-based sources and usually have high glass transition temperature (Tg) and high melting temperature (Tm) without any external plasticizers. Hence, short-chain cellulose esters require the addition of external plasticizers on melt processing to widen the processing window between the melting and degradation temperatures. These external plasticizers frequently give rise to extraction or volatilization. Solving by this problem, long chain cellulose esters have been studied, which cellulose esters are synthetized from longer chain fatty acids, and commonly a chain length of fatty acid substituent is at least C6. These long chain cellulose esters have shown relatively good mechanical and barrier properties and therefore show promising potential in several applications such as coatings, films and bioplastics.

Unfortunately, although cellulose can be chemically modified, e.g. via esterification to achieve a required functionality, such as making cellulose more hydrophobic or thermomoldable, or affecting mechanical properties or barrier properties, cellulose owns poor reactivity making its modification challenging and limiting its utilization. Long chain cellulose esters can be produced using both homogeneous and heterogeneous methods. In homogenous methods cellulose is commonly completely dissolved. Homogenous cellulose esterification can be performed using a lithium chloride/N,N-dimethylacetamide (LiCl/DMAc) as a solvent system. However, LiCl/DMAc is expensive and hazardous solvent and solvent recovery is difficult. Further, recycling the expensive lithium salt is challenging.

Fatty acid chloride is commonly used as a reagent to produce cellulose fatty acid esters. Fatty acid chloride may produce hydrochloric acid as a by-product of the esterification reaction, which may cause cellulose degradation. Therefore, cellulose degradation is typically limited by neutralizing formed hydrochloric acid (HCl) using e.g. pyridine or 4-dimethylaminopyridine (DMAP). However, pyridine and DMAP are expensive and hazardous. Pyridine also has an unpleasant fish-like smell. Further, pyridine and DMAP are hard to eliminate from the product, thus making the purification of the product time-consuming and excess amounts of washing solvents are needed.

As disclosed above, the known methods for modifying cellulose require large quantities of hazardous and expensive chemicals, and purification steps are time-consuming. Hence, the methods for modifying cellulose and producing long chain cellulose esters, which are simpler, cheaper and using non-toxic chemicals, are in high demand. Further, more sustainable methods to produce cellulose esters are desirable.

### SUMMARY OF THE INVENTION

It is an object of the present invention to reduce or even eliminate the above-mentioned problems appearing in prior art.

An object of the present invention is to provide a mechanochemical method for producing long chain cellulose esters, in which method esterification of cellulose is performed without hazardous and toxic organic solvents. An object of the invention is to use non-toxic and cheap chemicals in a method for producing long chain cellulose esters.

Further, an object of the present invention is to produce long chain cellulose esters having a high biobased material content. An object of the present invention is to utilize natural fatty acids in esterification of cellulose and hence increasing the biobased material content of the final long chain cellulose esters.

An object of the present invention is also to provide more sustainable method for producing long chain cellulose esters.

A typical method according to the invention for producing long chain cellulose esters is a mechanochemical synthesis, which comprises esterification of cellulose by mixing and subjecting to mechanical forces at least
cellulose,
a fatty acid and/or fatty acid derivative comprising a chain length of at least C6,
an alkali salt, and
a neural or alkaline drying agent,
wherein the long chain cellulose esters are obtained, which cellulose esters comprise a fatty acid having chain length of at least C6, and which esterification of cellulose is performed without using any organic solvents.

The present invention relates also to long chain cellulose esters having a fatty acid substituent with a chain length of at least C6 produced by the method according to the invention. A long chain cellulose ester according to the present invention comprises a fatty acid substituent with a chain length of at least C6 originated from natural sources.

In the method according to the present invention, mechanochemical synthesis is used to produce long chain cellulose esters having a fatty acid substituent with a chain length of C6 or longer. In the present invention long chain cellulose esters are synthetized from long chain fatty acids and/or fatty acid derivatives having a chain length of at least C6, preferably from natural long chain fatty acids and/or fatty acid derivatives having a chain length of at least C6. In a mechanochemical synthesis, a chemical reaction is induced and sustained using mechanical forces. The present invention provides a simple and environmentally friendly method to synthetize long chain cellulose esters. In the method according to the present invention, mechanochemical reaction is utilized to prepare long-chain cellulose esters from cellulose and natural fatty acids and/or derivates of natural fatty acids. In the present invention, fatty acids from natural origin increases the biobased material content of the obtained long chain cellulose esters. Using long chain fatty acid(s) from natural sources enhances the value of cellulose esters as sustainable materials. Hence, long chain cellulose esters according to the present invention are biobased cellulose esters with a fatty acid side chain length of C6 or longer.

The inventors of the present invention have developed a simple, cheap and sustainable method to synthesize long chain cellulose esters in mild conditions without using any hazardous and toxic organic solvents or other reagents in the esterification of cellulose. In a method according to the present invention, hazardous and toxic solvents, such as pyridine or DMAP in esterification synthesis are replaced by non-toxic and less hazardous chemicals. Less hazardous, non-toxic and relatively cheap chemicals are used in a method according to the present invention. In a method according to the present invention, esterification of cellulose is performed in absence of organic solvents. In a method according to the present invention, no organic solvent is used in the mechanochemical synthesis during esterification of cellulose, only purification step after synthesis may utilize an alcohol-based solvent. In the mechanochemical synthesis according to the present invention only simple purification step with water and an alcohol-based solvent is typically used, wherein the alcohol-based solvent can be distilled and recycled. Hence, a method according to the present invention also creates less waste and the excess of fatty acids can be recycled back to the synthesis.

Long chain fatty acid esterification increases cellulose esters' hydrophobicity. Hence, the long chain cellulose esters according to the present invention can be used as a hydrophobic agent. They can be used for forming barrier properties to a material to be treated, and they are suitable for many applications. In addition to hydrophobicity, long chain cellulose esters according to the present invention may form oxygen barrier and water resistance properties. Long chain cellulose esters can be used in paper or board applications, e.g. as an internal sizing agent and/or a coating agent. Long chain cellulose esters according to the present invention can be used e.g. in coating applications whereby they provide an alternative to materials produced from non-renewable materials. Long chain cellulose esters according to the present invention can also be used in a treatment of textile fibres. Hence, long chain cellulose esters according to the present invention can be used e.g., in paper or board manufacturing, and packaging and textile industry.

### DESCRIPTION OF THE DRAWINGS

The invention will be described in more detail with reference to appended drawings, in which

FIG. 1 shows FTIR spectrum of cellulose.

FIG. 2 shows FTIR spectrum of cellulose laurate. C═O stretching at 1742.45 cm⁻¹. C—H stretching at 2922.75 and 2853.97 cm⁻¹.

FIG. 3 shows 1H-NMR spectrum of cellulose.

FIG. 4 shows 1H-NMR spectrum of cellulose laurate.

FIG. 5 shows quantitative 13C NMR spectrum of cellulose.

FIG. 6 shows quantitative 13C NMR spectrum of cellulose laurate.

FIG. 7 shows pyrogram obtained by Py-GC/MS analysis of methylated cellulose.

FIG. 8 shows pyrogram obtained by Py-GC/MS analysis of methylated cellulose laurate.

FIG. 9 shows FTIR spectrum of cellulose palmitate. C═O stretching at 1739.93 cm⁻¹. C—H stretching at 2919.69 and 2851.92 cm⁻¹.

FIG. 10 shows differential scanning calorimetry (DSC) for cellulose.

FIG. 11 shows differential scanning calorimetry (DSC) for cellulose palmitate.

### DETAILED DESCRIPTION OF THE INVENTION

A method according to the present invention is based on esterification of cellulose with a long chain fatty acid and/or fatty acid derivative using mechanochemical synthesis. In the present disclosure, a long chain fatty acid refers to fatty acids having a chain length of 6 carbons or longer. A long chain fatty acid derivative refers to fatty acid derivatives having a chain length of fatty acid with 6 carbons or longer. A long chain cellulose ester according to the present invention comprises fatty acid having a chain length of C6 or longer (fatty acid substituents ≥C6). A long chain in the long chain cellulose ester refers to a chain length of fatty acid substituent in the cellulose ester. A long chain cellulose ester according to the present invention comprises a side chain originating from fatty acid and/or fatty acid derivative. In the present disclosure a fatty acid substituent refers to a side chain of the cellulose ester originating from fatty acid and/or fatty acid derivative. According to an embodiment of the present invention, a long chain cellulose ester produced by a method according to the present invention comprises at least one cellulose ester comprising a fatty acid (fatty acid substituent) with a chain length of at least 6 carbons (C6). According to other embodiments of the present invention, a long chain cellulose ester comprises at least cellulose ester comprising a fatty acid (fatty acid substituent) preferably with a chain length of at least C8, more preferably at least C10 and even more preferably at least C12. Using a method according to the present invention, long chain cellulose esters with different side chain lengths (fatty acid substituents ≥C6) can be synthesized.

In an embodiment of the present invention, a long chain cellulose ester produced by a method according to the present invention comprises at least one cellulose ester comprising a fatty acid substituent with a chain length of C6-C22, preferably C8-C22, more preferably C10-C22 and even more preferably C12-C22. In some embodiments, a long chain cellulose ester comprises at least one cellulose ester having a fatty acid substituent with a chain length of C6-C22, C6-C20, C6-C18, C8-C22, C8-C20, C8-C18, C10-C22, C10-C20, C10-C18, C12-C22, C12-C20 or C12-C18. In preferred embodiments of the invention, a long chain cellulose ester comprises at least one cellulose ester having a fatty acid substituent with an even number of carbons in chain length of C6-C22. In an embodiment of the present invention, a chain length of fatty acid substituent in cellulose ester produced by a method according to the present invention is C6, C8, C10, C12, C14, C16, C18, C20 or C22, preferably a chain length of fatty acid substituent in cellulose ester is C12, C14, C16 or C18. Hence, in a method according to the present invention, a fatty acid and/or a fatty acid derivative comprising a chain length of C6-C22, preferably C8-C22, more preferably C10-C22 and even more preferably C12-C22 is used as a reagent. In some embodiments, a fatty acid and/or a fatty acid derivative comprising a chain length of C6-C22, C6-C20, C6-C18, C8-C22, C8-C20, C8-C18, C10-C22, C10-C20, C10-C18, C12-C22, C12-C20 or C12-C18 is used as a reagent, preferably a chain length of C6-C22 with an even number of carbons. In an embodiment of the present invention, a chain length of fatty acid or fatty acid derivative is C6, C8, C10, C12, C14, C16, C18, C20 or C22, preferably a chain length of fatty acid or fatty acid derivative is C12, C14, C16, C18, C20 or C22, and more preferably C12, C14, C16 or C18. These fatty acids are typically inexpensive and non-toxic, and they are safe to handle and obtained from natural sources. Shorter side chain is easier to synthetize, but with longer fatty acid side chain may provide improved hydrophobicity of cellulose ester. Hydrophobicity of cellulose ester depends on chain length of fatty acid substituent and the degree of substitution (DS). The higher the content of hydrophobic nonpolar alkyl chain compared to hydrophilic hydroxyl groups of cellulose, the more hydrophobic cellulose ester is obtained. So, a chain length of the fatty acid side chain can be selected based on the end use and application.

According to an embodiment of the present invention, cellulose esters obtained by the method according to the present invention may be mixed long chain cellulose esters, wherein the obtained cellulose ester comprise a mixture of long chain cellulose esters having fatty acid substituents with different chain lengths. In an embodiment of the present invention, cellulose esters obtained by the method according to the present invention comprise a mixture of cellulose esters having a fatty acid substituent with a chain length of at least C6, preferably a chain length of C6-C22, more preferably a chain length of C6-C22 with an even number of carbons. In an embodiment of the present invention, cellulose esters obtained by the method according to the present invention comprise a mixture of cellulose esters having a fatty acid substituent with chain length of C6, C8, C10, C12, C14, C16, C18, C20 or C22, preferably a chain length of fatty acid substituent in cellulose ester is C12, C14, C16, C18, C20 or C22, and more preferably C12, C14, C16 or C18. Hence, the mixture of long chain fatty acids and/or fatty acid derivatives with different chain lengths can be used as a reagent in the method according to the invention. Fatty acids from natural sources are typically mixtures and there is not necessarily need to purify the fatty acid mixtures so that they would include only one fatty acid. Thus, a cheaper non-purified mixture of the different long chain fatty acids is possible to use in the method according to the invention.

According to an embodiment of the present invention, a fatty acid and/or fatty acid derivative may comprise saturated or unsaturated fatty acid. According to an embodiment of the present invention, a fatty acid used as a reagent in mechanochemical synthesis comprises caproic acid (C6), caprylic acid (C8), capric acid (C10), lauric acid (C12), myristic acid (C14), palmitic acid (C16), stearic acid (C18), arachidic acid (C20), behenic acid (C22) and any mixtures thereof. According to another embodiment of the present invention, a fatty acid derivate used as a reagent in mechanochemical synthesis comprises a derivate of caproic acid (C6), caprylic acid (C8), capric acid (C10), lauric acid (C12), myristic acid (C14), palmitic acid (C16), stearic acid (C18), arachidic acid (C20), behenic acid (C22) and any mixtures thereof. In some embodiments, fatty acid and/or fatty acid derivative may further comprise unsaturated fatty acids. In an exemplary embodiment, unsaturated fatty acid and/or fatty acid derivative comprises myristoleic acid, palmitoleic acid, sapienic acid, oleic acid and/or linoleic acid. Preferably, fatty acid and/or fatty acid derivative comprises saturated fatty acid and/or saturated fatty acid derivative, which has no C═C double bonds. Saturated fatty acids are more stable than unsaturated. However, the unsaturated fatty acids may decrease glass transition temperature (Tg) and/or melting point (Tm) of cellulose ester which is also valuable characteristic in some applications.

According to the present invention, fatty acid and/or fatty acid derivative is used as a reagent in the method. In a preferred embodiment of the invention, fatty acid derivatives are used, since reactivity of derivative is better. In an embodiment of a method according to the present invention, a fatty acid derivate may comprise fatty acid anhydride, mixed anhydride of fatty acids, fatty acid chloride, other activated fatty acid derivative or any combination thereof. In a preferred embodiment a fatty acid chloride, such as hexanoyl chloride, lauroyl chloride, myristoyl chloride, palmitoyl chloride, or stearoyl chloride is used. Fatty acid chloride is one preferred fatty acid derivative used in a method according to the present invention, since chloride has good reactivity.

According to the present invention, cellulose used as a raw material in an esterification synthesis may be from any natural origin. In an exemplary embodiment of the present invention, cellulose comprises nanocrystalline cellulose, microcrystalline cellulose or cellulose pulp. In an embodiment of the invention, cellulose can be a mixture of celluloses from different origins. In an exemplary embodiment of the present invention, cellulose material may originate e.g. from wood, sugar beets, bagasse, hemp, flax, abaca, jute, kapok, cotton, silk floss or any other natural origin comprising cellulose fibres. In an embodiment according to the present invention, cellulose used as a raw material in an esterification synthesis may comprise a pulp selected from native hardwood pulp, native softwood pulp, softwood kraft pulp, hardwood kraft pulp, dissolving pulp or any mixture thereof. In an embodiment of the present invention, a cellulose may comprise fibre material and/or recycled fibre material. In an embodiment of the present invention, cellulose comprise recycled fibre material comprising fibres of recycled paper or board. In another embodiment of the present invention, cellulose may comprise textile fibres or recycled textile fibres.

In an embodiment according to the present invention, cellulose used as a raw material in an esterification synthesis comprises dissolving pulp. According to an embodiment of the present invention, dissolving pulp, also called dissolving cellulose, comprise bleached wood pulp or cotton linters that has a high cellulose content, and particularly low hemicellulose and lignin content. In an embodiment of the present invention cellulose comprises a dissolving pulp made of softwood.

According to an embodiment of the present invention, cellulose used as a raw material in an esterification synthesis can comprise a pre-treated cellulose. In an embodiment according to the present invention, cellulose may be activated by enzymatic treatment, ozone treatment, hydrogen peroxide treatment, alkaline treatment, or other chemical treatment, or treated with steam, before performing a long chain fatty acid esterification. In another embodiment according to the present invention, cellulose may be treated mechanically before synthesis for improving reactivity. Cellulose may be e.g. grinded, refined or supplied through an extruder for improving its reactivity. Pre-treatment of cellulose activates cellulose and enhances esterification.

In a mechanochemical synthesis according to the present invention, no organic solvent is used in an esterification of cellulose, i.e. esterification of cellulose is performed in absence of organic solvent(s). A mechanochemical synthesis for esterification of cellulose according to the present invention is free of any organic solvents. In a mechanochemical synthesis according to the present invention, long chain cellulose esters are synthetized in mild conditions without using any hazardous and toxic organic solvents in the esterification of cellulose. Non-toxic and less hazardous chemicals are used in esterification of cellulose according to the present invention. No organic solvent is used during the esterification of cellulose, only purification step after synthesis may utilize an alcohol-based solvent. The esterification of cellulose can be stopped by using alcohol-based solvent, such as methanol, but during esterification of cellulose no organic solvents are not used.

According to the present invention, an alkali salt is added to a mechanochemical synthesis since an acidic by-product may be produced in the esterification reaction and it needs to be neutralized. If the acidic by-product is not neutralized, it may degrade the cellulose. An alkali salt comprises at least one alkali salt. An alkali salt can be any suitable alkali salt which can neutralize an acidic by-product produced in the esterification reaction. According to an embodiment of the present invention, an alkali salt, which is added to the mechanochemical synthesis, comprises carbonate or bicarbonate of an alkali metal or an alkaline earth metal. An alkali added to the synthesis protects the cellulose from degradation, and it may also act as a catalytic agent in esterification process.

Further, a neutral or alkaline drying agent is added to a mechanochemical synthesis according to the present invention. A drying agent comprises at least one neutral or alkaline drying agent. A pH value of 7.0 corresponds to a neutral pH, and pH values above 7.0 are considered alkaline. In an embodiment according to the present invention, a neutral or alkaline drying agent has a pH in the range of 7.0-14.0 or 7.0-12.0 or 7.0-10.0. In an embodiment according to the present invention, a neutral or alkaline drying agent comprises an inorganic salt capable of forming an inorganic hydrated salt. Organic salt is favourable since it dissolves in water and hence the purification of the obtained cellulose ester can be performed easily. In an embodiment according to the present invention, a drying agent may comprise silica and/or molecular sieves. In an embodiment according to the present invention, an inorganic salt capable of forming an inorganic hydrated salt comprises anhydrous sodium sulphate or calcium sulphate. Esterification reaction creates water, and the reaction equilibrium favours starting materials instead of ester, if water is present and hence a drying agent is required in the synthesis for guaranteeing the esterification reaction. Further, an acidic by-product may be produced in the esterification reaction, which may cause cellulose degradation. Hence, a neutral or alkaline drying agent is used in the method according to the present invention to avoid degradation of cellulose. For this reason, a drying agent used in a method according to the present invention does not comprise any acidic drying agent. In a method according to the present invention, a drying agent does not comprise Lewis acid, such as e.g. ZnCl₂ or AlCl₃.

In a method according to the present invention, mechanochemical synthesis is used to synthetize long chain cellulose esters from cellulose and long chain fatty acids and/or long chain fatty acid derivates in a presence of at least one alkali salt and at least one drying agent. Mechanical activation may be favourable since fatty acid and/or fatty acid derivatives as such have very low reactivity towards cellulose hydroxyl groups. In a mechanochemical synthesis a chemical reaction is induced and sustained using mechanical forces, such as by grinding, milling or supplying through an extruder. Mechanical forces can be provided by any suitable method. In an embodiment according to the present invention, mechanochemical synthesis can be performed using a ball-mill, an extruder, a blender, a homogenizer or any other suitable equipment in which cellulose can be subjected to mechanical forces. According to a preferred embodiment of the present invention, mechanical forces of mechanochemical synthesis are provided by ball-milling. Ball-milling is a simple, fast and cost-effective way for mechanochemical processing of cellulose. Hence, according to a preferred embodiment of the present invention a method comprises esterification of cellulose by mixing and subjecting to mechanical forces cellulose, a fatty acid and/or a fatty acid derivative comprising a chain length of at least C6, at least one alkali salt and at least one drying agent in a ball mill, wherein the cellulose ester comprising a fatty acid substituent having chain length of at least C6 is obtained. In grinding or milling, such as in ball-milling, cellulose is subjected to the intense milling, wherein the structure of cellulose can be activated and hence its reactivity with fatty acid(s) and/or fatty acid derivative(s) is improved. In the present invention, milling or grinding of cellulose and esterification reaction are combined in mechanochemical synthesis. Subjecting to mechanical forces, such as grinding or milling is continued a required time for performing esterification reaction and achieving desired degree of substitution. In an exemplary embodiment of the present invention, mechanochemical synthesis may be continued e.g. about 30 minutes-3 days.

According to an embodiment of the present invention, the method i.e. mechanochemical synthesis is performed at temperature of 10-120° C., preferably 20-70° C. or 20-80° C., and more preferably 20-50° C. In an embodiment according to the present invention, the mechanochemical synthesis is performed at room temperature, i.e. about at 20-25° C. Hence, the method according to the present invention is a simple method since it does not necessarily require any heating. The reaction rate can be increased by heating, but the temperature <120° C., <90° C., <70° C. or <50° C. is preferred in order to avoid unnecessary side reactions and to save energy.

In an embodiment of the invention, all components of the reaction are added simultaneously and subjected to mixing and mechanical forces. According to an embodiment of the present invention, at least part of cellulose, at least part of at least one alkali salt and at least part of at least one drying agent are mixed and subjected to mechanical forces prior to addition of fatty acid and/or fatty acid derivative in a mechanochemical synthesis. In an embodiment according to the present invention, at least part of cellulose is subjected to mechanical forces prior to addition of an alkali salt, a drying agent and fatty acid and/or fatty acid derivative,. In this way the reactivity of cellulose with fatty acid and/or fatty acid derivative may be improved.

In a method according to the present invention, a fatty acid and/or fatty acid derivative can be added to the synthesis in one, two or more portions, or a fatty acid and/or fatty acid derivative is added continuously to the synthesis. Further, an alkali salt and a drying agent may be added to a synthesis simultaneously with a fatty acid and/or fatty acid derivate in order that they are present adequate amount in esterification reaction. A degree of substitution of the cellulose ester can be increased by adding fatty acid and/or fatty acid derivate continuously during the synthesis.

In a typical method according to the present invention, a fatty acid and/or fatty acid derivative is added in an amount of 1-10 mol to 1 mol of OH⁻ group of cellulose. In a method according to the present invention, there is no need to add fatty acid and/or fatty acid derivate in excess to the synthesis.

According to an embodiment of the present invention, a method further comprises adding a catalytic agent to the mechanochemical synthesis. In an embodiment of the present invention, a catalytic agent comprises polyethylene glycol (PEG) or its derivative.

In an exemplary embodiment of the mechanochemical synthesis according to the present invention, sodium carbonate as an alkali salt, sodium sulphate as a drying agent, relatively low excess of long chain fatty acid chloride and PEG are used in esterification of cellulose in a ball-mill without using any organic solvent in esterification of cellulose.

In the mechanochemical synthesis according to the present invention, it is only used simple purification step with water and alcohol-based solvent. Alcohol-based solvent used in purification step can be distilled and recycled. In an embodiment of the present invention only water and methanol or other alcohol-based solvent are used in the purification process. According to an embodiment of the present invention, a method comprises a washing step for purifying the obtained long chain cellulose ester, in which washing step the obtained cellulose ester is washed with a washing solution comprising an alcohol-based solvent, wherein the excess of fatty acid and/or fatty acid derivate is removed from the obtained long chain cellulose ester to the washing solution. After the washing step the washing solution comprising the alcohol-based solvent and fatty acid and/or fatty acid derivate can be distilled and the separated fatty acid or fatty acid derivate can be recycled to the mechanochemical synthesis of the long chain cellulose ester. Alternatively, the recovered alcohol-based solvent and fatty acid and/or fatty acid derivate can be used in other applications.

A long chain cellulose ester according to the present invention comprising a fatty acid side chain with a chain length of at least C6 is produced by the method according to the invention. Characteristics of the long chain cellulose ester can be altered by altering the fatty acid and/or the fatty acid derivate or by selecting cellulose from different origins or altering pre-treatment of cellulose. Long chain cellulose ester according to the present invention has typically an average degree of substitution in the range of 0.01-3.

Long chain cellulose esters according to the present invention are thermoplastic polymers. Long chain cellulose esters according to the invention have hydrophobic properties. Hence, they can be used as a hydrophobic agent. Cellulose esters according to the present invention can be used as a barrier layer in coating applications or as a film forming material. Cellulose esters according to the present invention can also be used to provide water barrier and/or oxygen barrier properties to the materials. Long chain cellulose esters according to the present invention are capable to form continuous films with good barrier properties.

Long chain cellulose esters can be used in paper or board manufacturing, e.g. as an internal sizing agent and/or a coating agent. Long chain cellulose esters according to the present invention can be used e.g. in coating applications in packaging industry. According to the present invention, long chain cellulose esters can be used in a method, which comprises an addition of them to the fibre stock and/or applied on a surface of fibre web. Long chain cellulose esters according to the present invention can also be used in a treatment of textile fibres. According to the present invention, long chain cellulose esters can be used in a method, which comprises treating of textile fibres using long chain cellulose esters. Hence, long chain cellulose esters according to the present invention can be used e.g. in paper or board manufacturing, and packaging and textile industry.

### EXAMPLES

### Methods and Equipment Used in Examples 1 and 2

Nuclear magnetic resonance spectroscopy (NMR): Bruker Avance 400 NMR instrument with 5 mm PABBO BB-1H/D Z-GRD Probe, in [P4444][OAc]:DMSO-d6 (w/w 1:4) at 65° C.

Fourier-transform infrared spectroscopy (FTIR): Nicolet iS50 FT-IR ATR diamond; Scanning range 400-4000 cm⁻¹.

Pyrolysis-gas chromatography-mass spectrometry (Pyrolysis-GC-MS): For each test, the mass of the sample approximately 0.1-0.2 mg was placed into the sample cup. All the tested samples were analyzed without and with methylation with tetramethylammonium hydroxide (TMAH). In TMAH analysis approximately 4 μl of TMAH was added into the sample cup after the sample addition, and analyzed with pyrolysis-GC-MS.

Pyrolysis gas chromatography/mass spectrometry (Pyrolysis-GC-MS) was carried out using pyrolyzer (Frontier EGA/PY-3030D) coupled to a gas chromatograph equipped with a single quadrupole mass spectrometer (Shimadzu GCMS-QP2010 SE). A sample was pyrolyzed using single shot pyrolysis carried out at 600° C. temperature for 30 seconds under Helium (He) atmosphere. The pyrolysis products were separated through GC using a ZB-5HT Inferno column (30 m×0.25 mm, 0.25um film thickness). The injector temperature was kept at 290° C. Helium (5.6) was used as a carrier gas with a linear velocity of 43 cm/s. Pyrolysis products were injected with a split of 1:39. The GC oven temperature program was set as follows: 50° C. (held for 1 min) to 350° C. (held for 10 min) at a heating rate of 15° C./min. The interface temperature of GC to MS was 320° C. and the electron ionization (70 eV) was used to ionize the pyrolysis products. The MS source temperature was 230° C. and a mass range from 35 to 800 m/z was scanned. Each separated peak was identified by interpreting its mass spectrum with using NIST MS library.

Differential Scanning Calorimetry (DSC): Mettler Toledo DSC 3+. Aluminum 40 μl pan pierced. 10.00 K/min, N₂ flow rate 50.0 ml/min. Temperature cycle: 1^{st} heating: −65.0→200.0° C., cooling: 200.0→−65.0° C. and 2^{nd} heating: −65.0→200.0° C.

The dissolving pulp made of softwood was used as a reference. The reference was freeze dried and analyzed by using the methods mentioned above.

### Example 1

Cellulose (dissolving pulp made of softwood, 6.02 g), PEG400 monooleate (4.1 g), sodium carbonate (Na₂CO₃, 6.29 g) as an alkali salt and sodium sulphate (Na₂SO₄, 4.0 g) as a drying agent were mixed together with ceramic beads for 1 h. Lauroyl chloride was added (12.0 g) and mixed for 21.5 h with beads in a ball mill. More lauroyl chloride (12.7 g) and Na₂CO₃ (5.0 g) were added and mixed for 4 h. Mixture was stopped by adding methanol (MeOH, 200 ml) to the mixture and mixed for 1 h. The mixture was filtered, and washed with warm MeOH (100 ml, 50° C.), water (300 ml), and MeOH. The obtained off-white cellulose laurate (C12) was dried in an oven at 70° C. for 16 h. Oven dried yield 9 g. The cellulose laurate was then freeze dried and characterized using Fourier-transform infrared spectroscopy (FTIR), nuclear magnetic resonance spectroscopy (NMR), and pyrolysis gas chromatography/mass spectrometry (Pyrolysis-GC-MS).

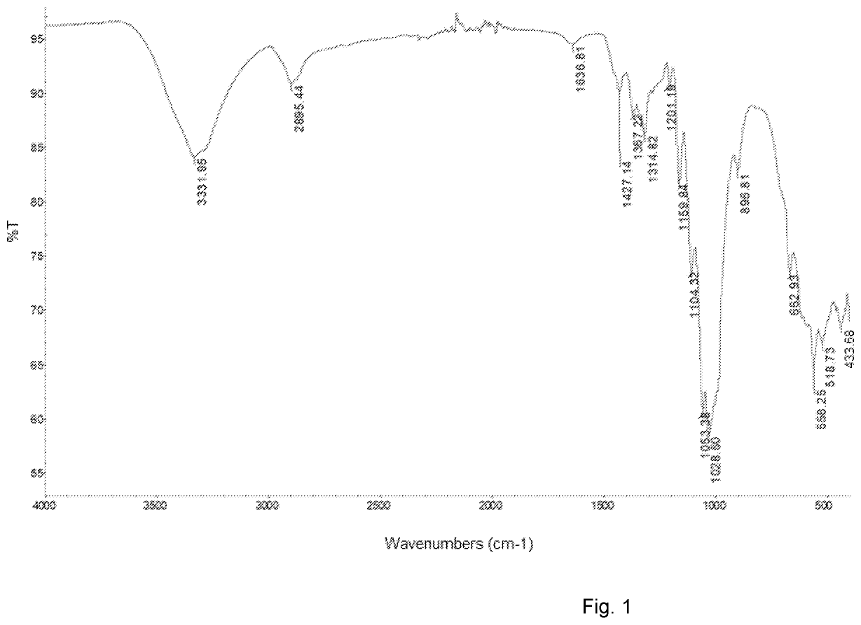

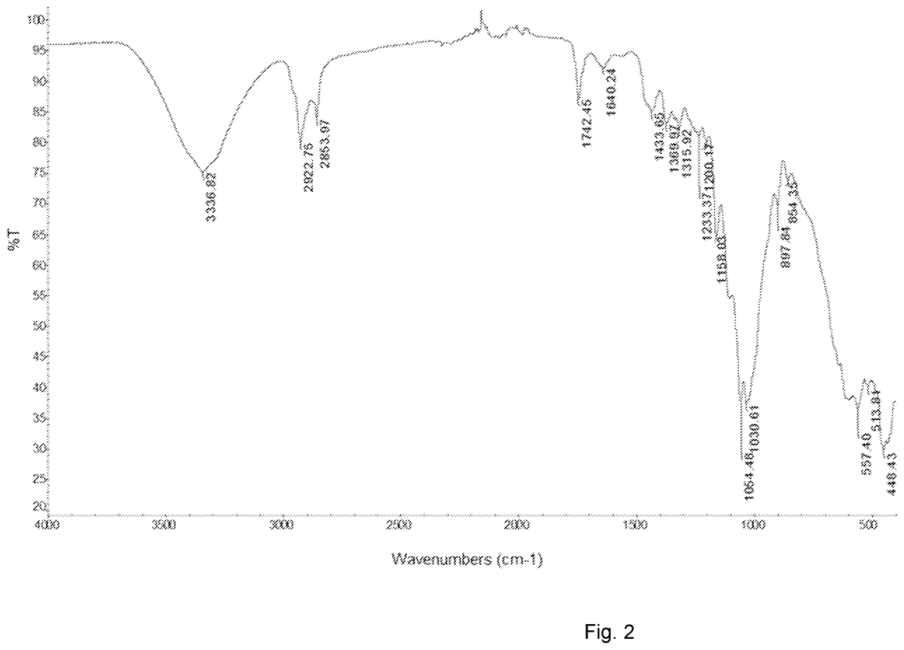

FIG. 1 shows FTIR spectrum of cellulose (dissolving pulp). From FIG. 2, which shows FTIR spectrum of cellulose laurate, can be observed that the fatty acid has reacted with the cellulose, and a cellulose laurate (C12) has been formed. The characteristic IR band position for ester C═O is seen at 1742.45 cm⁻¹ and laurate side chain with C—CH₃ and CH₂ at 2922.75 and 2853.97 cm⁻¹ indicating that the fatty acid has reacted with the cellulose, and a cellulose laurate has been formed.

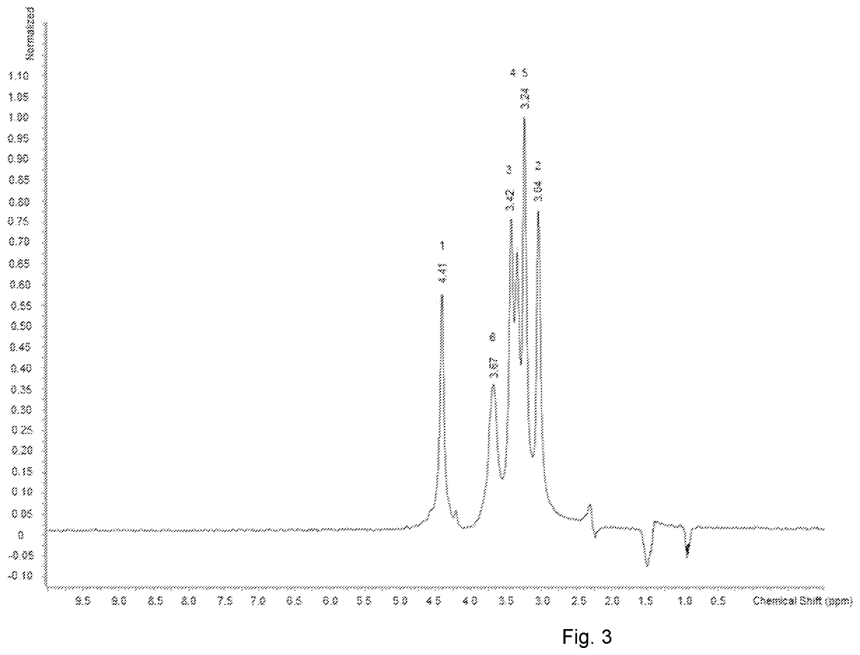

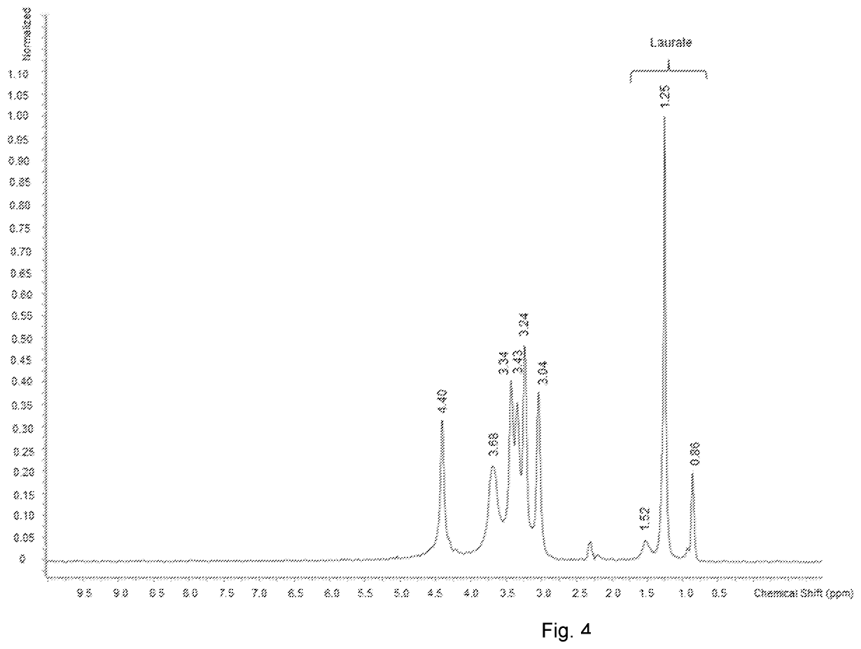

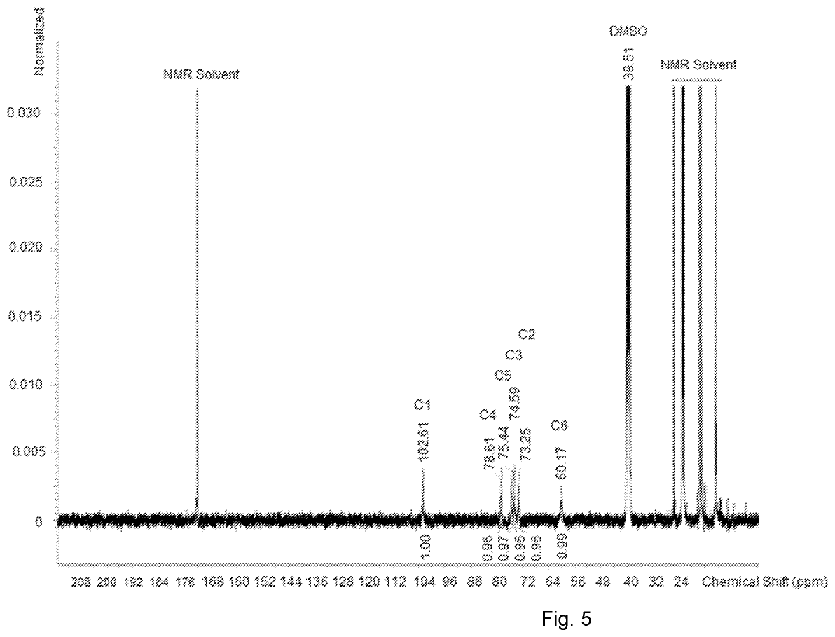

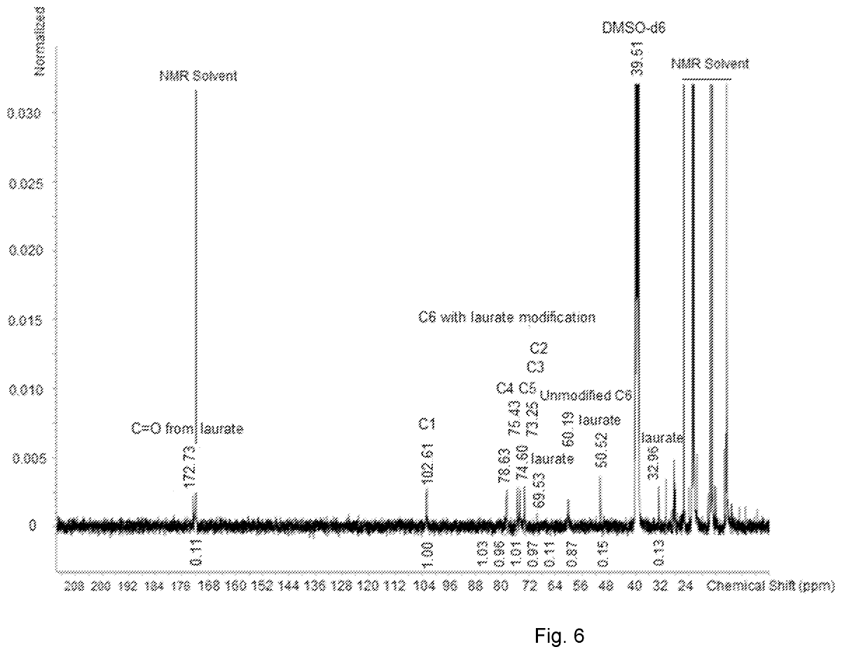

1H-NMR spectra for cellulose is showed in FIG. 3 and cellulose laurate in FIG. 4. The laurate sidechain is easily identified from the 1H-NMR spectrum of the sample at 0.86-1.52 ppm. Quantitative 13C-NMR spectrum of cellulose is shown in FIG. 5 and cellulose laurate in FIG. 6. From the 13C-NMR cellulose laurate spectrum it can be seen that a carbonyl of ester bond is observed at 172.73 ppm, and the carbonyl is attached mostly to cellulose C6 position (60.19 ppm), and DS is between 0.11 and 0.15. The NMR spectra clearly show that the sample is cellulose laurate.

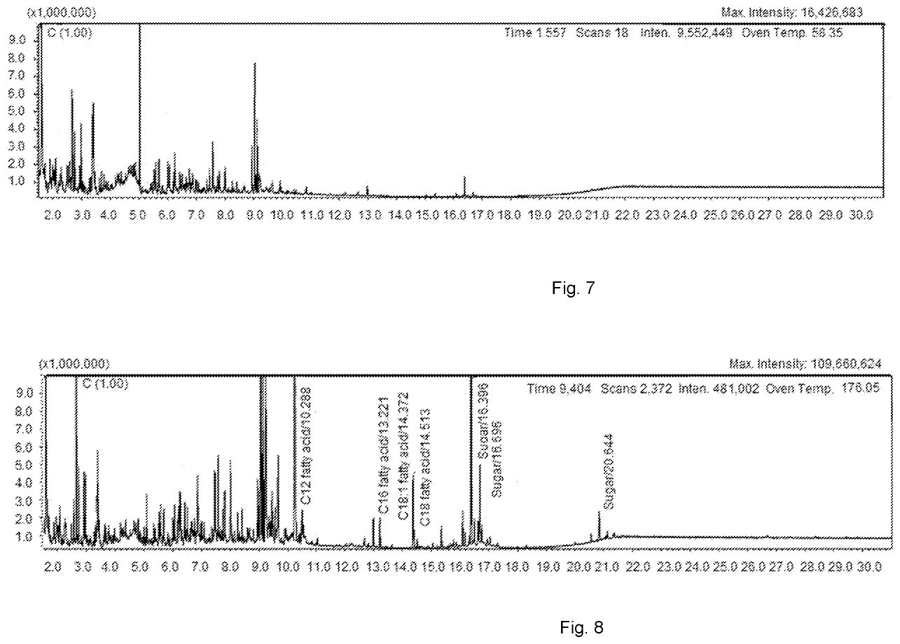

FIG. 7 and FIG. 8 show Pyrolysis-GC-MS pyrograms for methylated cellulose and cellulose laurate. In FIG. 8 fatty acid (C12) is identified and has an intense peak at 10.29 min. Fatty acid (C12) is absent in FIG. 7.

The obtained cellulose laurate is off-white product by visual inspection of the product, which indicates that no degradation of the cellulose laurate has been taken place.

### Example 2

Cellulose (dissolving pulp made of softwood, 1.64 g), PEG 400 monooleate (0.8 g), sodium carbonate (Na₂CO₃, 0.60 g) as an alkali salt and sodium sulphate (Na₂SO₄, 8.0 g) as a drying agent were mixed together with ceramic beads for 1 h. Palmitoyl chloride was added (3.06 g) and mixed for 2 h with beads in a ball mill. More palmitoyl chloride (3.0 g) and Na₂CO₃ (0.6 g) were added and mixed for 16 h. More palmitoyl chloride (3.0 g) and Na₂CO₃ (0.6 g) were added and mixed for 5 h. Mixture was stopped by adding methanol (MeOH, 200 ml) to the mixture and mixed for 1 h. The mixture was filtered, and washed with warm MeOH (100 ml, 50° C.), warm water (300 ml, 60° C.), and warm MeOH (100 ml, 50° C.). The obtained off-white cellulose palmitate (C16) was dried in an oven at 70° C. for 16 h. Oven dried yield 1.89 g. The sample was then freeze dried and characterized using Fourier-transform infrared spectroscopy (FTIR) and differential scanning calorimetry (DSC).

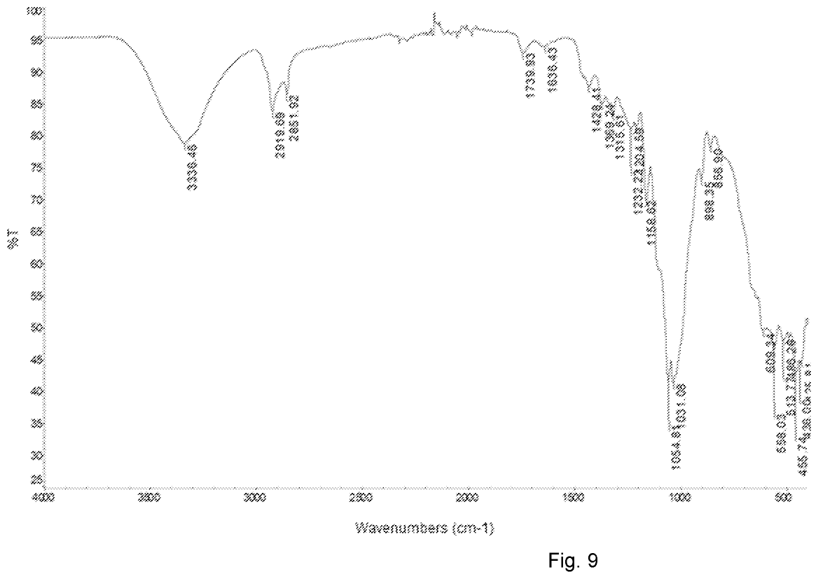

FIG. 9 shows FTIR spectrum, from which can be observed that the fatty acid has reacted with the cellulose (FIG. 1), and a cellulose palmitate (C16) has been formed. The characteristic IR band position for ester C═O is seen at 1739.93 cm⁻¹ and palmitate side chain with C—CH₃ and CH₂ at 2919.69 and 2851.92 cm⁻¹ indicating that the fatty acid has reacted with the cellulose, and a cellulose palmitate has been formed.

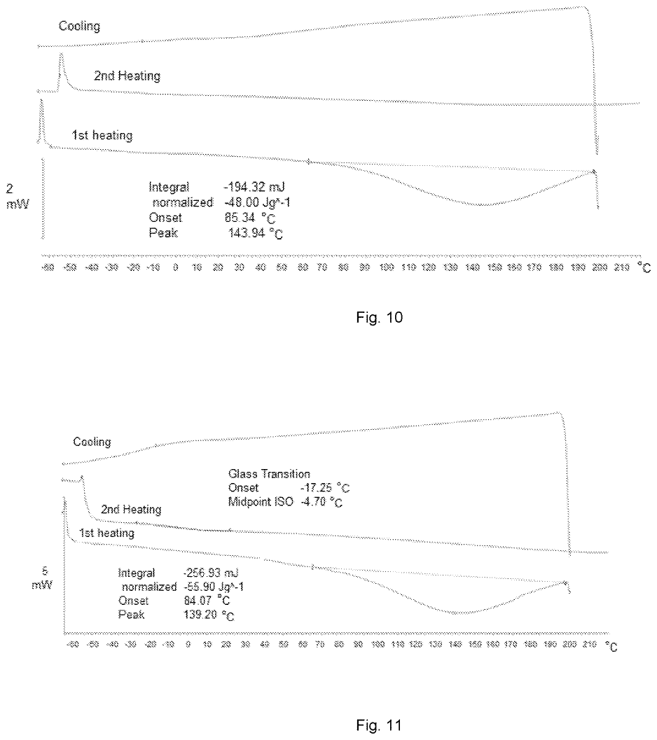

FIG. 10 and FIG. 11 show the results of DSC for cellulose and cellulose palmitate. 1st heating indicates remaining water in both samples, 2nd heating shows the real observation of the onset glass transition at −17.25° C. for cellulose palmitate (FIG. 11). No glass transition is observed for cellulose (FIG. 10).

The obtained cellulose palmitate is off-white product by visual inspection of the product, which indicates that no degradation of the cellulose palmitate has been taken place.

1. A method for producing long chain cellulose esters, wherein the method is a mechanochemical synthesis, which method comprises esterification of cellulose by mixing and subjecting to mechanical forces at least
cellulose,
a fatty acid and/or a fatty acid derivative comprising a chain length of at least C6,
an alkali salt, and
a neutral or alkaline drying agent,
wherein the long chain cellulose esters are obtained, which cellulose esters comprise a fatty acid having chain length of at least C6, and which esterification of cellulose is performed without using any organic solvents.

2. The method according to claim 1, wherein long chain cellulose esters comprise cellulose ester comprising a fatty acid preferably with a chain length of at least C8, more preferably at least C10 and even more preferably at least C12.

3. The method according to claim 1, wherein the long chain cellulose esters comprise cellulose ester comprising a fatty acid with a chain length of C6, C8, C10, C12, C14, C16, C18, C20 or C22, preferably a chain length of C12, C14, C16 or C18.

4. The method according to claim 1, wherein the fatty acid derivate comprises fatty acid anhydride, mixed anhydride of fatty acids, fatty acid chloride, other activated fatty acid derivative or any combination thereof.

5. The method according to claim 1, wherein the fatty acid and/or fatty acid derivative comprises a mixture of fatty acids having different chain lengths.

6. The method according to claim 1, wherein an alkali salt comprises carbonate or bicarbonate of an alkali metal or an alkaline earth metal.

7. The method according to claim 1, wherein a drying agent comprises an inorganic salt capable of forming an inorganic hydrated salt, preferably anhydrous sodium sulphate or calcium sulphate.

8. The method according to claim 1, wherein a drying agent comprises silica and/or molecular sieves.

9. The method according to claim 1, wherein the method is performed at temperature of 10-120° C., preferably 20-70° C. or 20-50° C.

10. The method according to claim 1, wherein
at least part of cellulose is subjected to mechanical forces prior to addition of an alkali salt, a drying agent and fatty acid and/or fatty acid derivative, or
at least part of cellulose, at least part of the alkali salt and at least part of the drying agent are mixed and subjected to mechanical forces prior to addition of fatty acid and/or fatty acid derivative.

11. The method according to claim 1, wherein the fatty acid and/or fatty acid derivative is added to the synthesis in one, two or more portions, or fatty acid and/or fatty acid derivative is added continuously to the synthesis.

12. The method according to claim 1. wherein the method further comprises adding a catalytic agent to the synthesis.

13. The method according to claim 1, wherein the method comprises a washing step for purifying the obtained long chain cellulose ester, in which washing step the obtained cellulose ester is washed with a washing solution comprising an alcohol-based solvent, wherein the excess of fatty acid and/or fatty acid derivate is removed from the obtained long chain cellulose ester to the washing solution.

14. The method according to claim 13, wherein after the washing step the washing solution comprising the alcohol-based solvent and fatty acid and/or fatty acid derivate is distilled and the separated fatty acid and/or fatty acid derivate is recycled to the mechanochemical synthesis of the long chain cellulose ester.

15. The method according to claim 1, wherein the fatty acid and/or fatty acid derivative is added in an amount of 1-10 mol to 1 mol of OH⁻ group of cellulose.

16. A long chain cellulose ester comprising a fatty acid substituent with a chain length of at least C6 produced by the method according to claim 1.

17. The long chain cellulose ester according to claim 16, wherein the cellulose ester has an average degree of substitution in the range of 0.01-3.

18. A method of using the long chain cellulose ester according to claim 16 as a hydrophobic agent.

19. The method according to claim 18, wherein the hydrophobic agent is used in paper or board manufacturing, or in a treatment of textile fibres.
